(19) United States
(12) Patent Application Publication
(10) Pub. No.: US 2026/0163613 A1
(43) Pub. Date: Jun. 11, 2026

(54) MULTIPLE-INPUT MULTIPLE-OUTPUT ORTHOGONAL FREQUENCY DIVISION MULTIPLEXING COMMUNICATION SYSTEM AND LOG LIKELIHOOD RATIO SCALING METHOD THEREOF

(71) Applicant: REALTEK SEMICONDUCTOR CORPORATION, Hsinchu (TW)

(72) Inventor: Chun-Chieh Tseng, Hsinchu (TW)

(21) Appl. No.: 19/366,629

(22) Filed: Oct. 23, 2025

(30) Foreign Application Priority Data
Dec. 10, 2024 (TW) 113147978

(51) Int. Cl. H04B 7/0426; H04B 17/318

(52) U.S. Cl. CPC H04B 7/0426; H04B 17/318

(57) ABSTRACT

A log-likelihood ratio scaling method includes: during a preamble period, determining a channel gain of a corresponding subcarrier and an average channel gain value of all subcarriers according to the preamble of a packet, determining a log-likelihood ratio average value according to the average channel gain value and the scaling parameter, and determining a scaling factor according to the average channel gain value, the channel gain and a scaling parameter; and during a payload period, generating an original log-likelihood ratio sequence according to the payload of the packet, adjusting the original log-likelihood ratio sequence according to the log-likelihood ratio average value and the scaling factor to generate a first log-likelihood ratio sequence, and adjusting the first log-likelihood ratio sequence according to the scaling factor to generate a second log-likelihood ratio sequence, where the second log-likelihood ratio sequence is quantized and decoded to provide the relevant information of the payload.

### BACKGROUND OF THE INVENTION

### 1. Field of the Invention

The present disclosure relates to an orthogonal frequency division multiplexing communication system, especially to a multiple-input multiple-output orthogonal frequency division multiplexing communication system and a log-likelihood ratio scaling method thereof, in which a scaling factor is identified during preamble period of a packet using mutual information.

### 2. Description of Related Art

Existing communication systems use error correction coding to correct the detected errors during data transmission. The popular LDPC code family is widely used nowadays. In the receiver, the input to a channel decoder is a sequence of log-likelihood ratios (LLRs) associated with a sequence of the sent coded bits. As a matter of fact, the complexity of the channel decoder grows increasingly with word length of LLR. It is therefore imperative to restrict and reduce the word length of the input log-likelihood ratio. However, directly reducing the word length without proper manipulation results in information loss and degraded decoding performance. A simple solution is to multiply the log-likelihood ratio by a pre-determined fixed scaling factor before reducing the word length. However, determining the scaling factor has been highly challenging, as it must be set and optimized under a huge combination of various channel conditions and system parameters, such as channel types, packet formats, modulation and coding schemes (MCS), MIMO schemes, number of spatial streams, bandwidth, and so forth. Finding an effective and automatic skill that can pre-determine the fixed scaling factor during decoding period and then keeping LLRs at pre-determined low word length become critical for designing a low-complexity decoder.

### SUMMARY OF THE INVENTION

In some aspects of the present disclosure, an object of the present disclosure is, but not limited to, provide a multiple-input multiple-output orthogonal frequency division multiplexing communication system and a log-likelihood ratio scaling method thereof, in which a scaling factor is identified during a preamble period of a packet using mutual information, so as to make an improvement to the prior art.

In some aspects of the present disclosure, a multiple-input multiple-output (MIMO) orthogonal frequency division multiplexing communication system includes a channel gain estimation circuit, a scaling factor estimation circuit, a maximum likelihood detection circuit, a first scaling circuit, a second scaling circuit, a quantizer circuit, and a channel decoder circuit. The channel gain estimation circuit is configured to, during a preamble period of a packet, determine a channel gain of a corresponding subcarrier in a plurality of subcarriers and an average channel gain value of the plurality of subcarriers according to a preamble of the packet, and determine a log-likelihood ratio average value according to the average channel gain value. The scaling factor estimation circuit is configured to, during the preamble period, determine a scaling factor according to the average channel gain value, the channel gain of the corresponding subcarrier, and a scaling parameter. The maximum likelihood detection circuit is configured to, during a payload period of the packet, generate an original log-likelihood ratio sequence according to a payload of the packet. The first scaling circuit is configured to, during the payload period, adjust the original log-likelihood ratio sequence according to the log-likelihood ratio average value and the scaling parameter to generate a first log-likelihood ratio sequence. The second scaling circuit configured to, during the payload period, adjust the first log-likelihood ratio sequence according to the scaling factor to generate a second log-likelihood ratio sequence. The quantizer circuit is configured to, during the payload period, quantize the second log-likelihood ratio sequence to generate quantized data. The channel decoder circuit is configured to, during the payload period, decode the quantized data to obtain relevant information of the payload.

In some aspects of the present disclosure, a log-likelihood ratio scaling method, which is executed by a multiple-input multiple-output orthogonal frequency division multiplexing communication system, includes the following operations: during a preamble period of a packet according to a preamble of the packet, determining a channel gain of a corresponding subcarrier in a plurality of subcarriers and an average channel gain value of the plurality of subcarriers, and determining a log-likelihood ratio average value according to the average channel gain value; during the preamble period, determining a scaling factor according to the average channel gain value, the channel gain of the corresponding subcarrier, and a scaling parameter; during a payload period of the packet, generating an original log-likelihood ratio sequence according to a payload of the packet; during the payload period, adjusting the original log-likelihood ratio sequence according to the log-likelihood ratio average value and the scaling parameter to generate a first log-likelihood ratio sequence; and during the payload period, adjusting the first log-likelihood ratio sequence according to the scaling factor to generate a second log-likelihood ratio sequence, wherein the multiple-input multiple-output orthogonal frequency division multiplexing communication system quantizes and decodes the second log-likelihood ratio sequence to obtain relevant information of the payload.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a multiple-input multiple-output (MIMO) orthogonal frequency division multiplexing communication system according to some embodiments of the present disclosure.

FIG. 2 illustrates a flowchart illustrating the operations of the channel gain estimation circuit FIG. 1 according to some embodiments of the present disclosure.

FIG. 3 illustrates a flowchart illustrating a log-likelihood ratio scaling method according to some embodiments of the present disclosure.

FIG. 4 illustrates a schematic diagram of a log-likelihood ratio scaling mechanism according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system formed with one or more circuits, and the term “circuit” may indicate an object, which is formed with one or more transistors and/or one or more active/passive elements according to a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, like elements in various figures are designated with the same reference number.

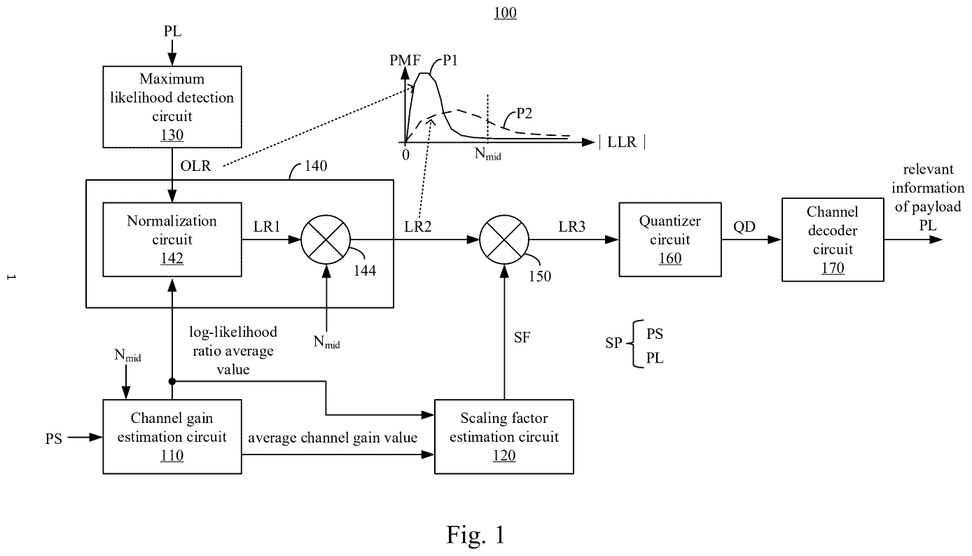

FIG. 1 illustrates a schematic diagram of a multiple-input multiple-output (MIMO) orthogonal frequency division multiplexing (OFDM) communication system 100 according to some embodiments of the present disclosure. For simplicity, FIG. 1 primarily illustrates the receiver of the MIMO OFDM communication system 100. It is understood that, in different embodiments, the MIMO OFDM communication system 100 may also include a transmitter that sends packets or data. The MIMO OFDM communication system 100 includes a channel gain estimation circuit 110, a scaling factor estimation circuit 120, a maximum likelihood detection (MILD) circuit 130, a scaling circuit 140, a scaling circuit 150, a quantizer circuit 160, and a channel decoder circuit 170.

The channel gain estimation circuit 110 may, during a preamble period of a packet SP, determine a channel response (e.g., a channel gain of a corresponding subcarrier) of a plurality of subcarriers (for example, but not limited to, all subcarriers) according to a preamble PS of the packet SP, and determine an average channel gain value of the subcarriers accordingly. The channel gain estimation circuit 110 further determines a log-likelihood ratio average value according to the average channel gain value. The scaling factor estimation circuit 120 is configured to determine a scaling factor SF during the preamble period of the packet SP according to the average channel gain value. Related operations and mathematical calculations of the channel gain estimation circuit 110 and the scaling factor estimation circuit 120 will be described later.

The maximum likelihood detection circuit 130 is configured to generate an original log-likelihood ratio (LLR) sequence OLR during a payload period of the packet SP according to a payload PL of the packet SP. In some embodiments, the payload PL is data transmitted in the packet SP following the preamble PS. In some embodiments, the original log-likelihood ratio sequence OLR may be used to indicate the likelihood of each bit in the payload PL with respect to possible data values (typically logic 0 or logic 1, but not limited thereto). In some embodiments, the maximum likelihood detection circuit 130 may perform sphere decoding algorithm, iterative decoding algorithm, and/or tree search decoding algorithm according to the payload PL, so as to generate the original log-likelihood ratio sequence OLR. The above types of algorithms used by the maximum likelihood detection circuit 130 are given for illustrative purposes only, and the present disclosure is not limited thereof.

The scaling circuit 140 is configured to adjust the original log-likelihood ratio sequence OLR during the payload period of the packet SP according to the log-likelihood ratio average value and a scaling parameter N_{mid}, so as to generate a log-likelihood ratio sequence LR2. In great detail, in some embodiments, the scaling circuit 140 includes a normalization circuit 142 and a multiplier circuit 144. The normalization circuit 142 is configured to normalize the original log-likelihood ratio sequence OLR during the payload period of the packet SP according to the log-likelihood ratio average value, so as to generate a log-likelihood ratio sequence LR1. The multiplier circuit 144 is configured to multiply the scaling parameter N_{mid} and the log-likelihood ratio sequence LR1 during the payload period of the packet SP, so as to generate the log-likelihood ratio sequence LR2.

In some embodiments, the scaling parameter N_{mid} is determined according to a word length n_{T} of the original log-likelihood ratio sequence OLR, and its value is approximately the average value of a probability mass function P1 corresponding to the original log-likelihood ratio sequence OLR. In some embodiments, the scaling parameter N_{mid} may be expressed by the following equation:

$${N}_{mid} = {2}^{{n}_{T} - 2}$$

In some embodiments, as shown in FIG. 1, the distribution of the probability mass function P1 corresponding to the original log-likelihood ratio sequence OLR is concentrated in a lower-value region of the log-likelihood ratio sequence (i.e., a lower value region that is labeled as |LLR|). In contrast, after being adjusted by the scaling parameter N_{mid}, the distribution of the probability mass function P2 corresponding to the log-likelihood ratio sequence LR2 becomes more uniform. As a result, the preliminary scaling of the original log-likelihood ratio sequence OLR may be achieved.

The scaling circuit 150 adjusts the log-likelihood ratio sequence LR2 during the payload period of the packet SP according to the scaling factor SF, so as to generate a log-likelihood ratio sequence LR3. With the arrangement of the scaling circuit 140 and the scaling circuit 150, the data size of the original log-likelihood ratio sequence OLR can be reduced (e.g., the total bit number of the log-likelihood ratio sequence LR3 is less than that of the original log-likelihood ratio sequence OLR), thereby reducing the complexity and hardware cost of the channel decoder circuit 170. In some embodiments, the scaling circuit 150 may be implemented with a multiplier circuit, but the present disclosure is not limited thereto. The quantizer circuit 160 quantizes the log-likelihood ratio sequence LR3 during the payload period to generate quantized data QD. The channel decoder circuit 170 decodes the quantized data QD to obtain relevant information of the payload PL.

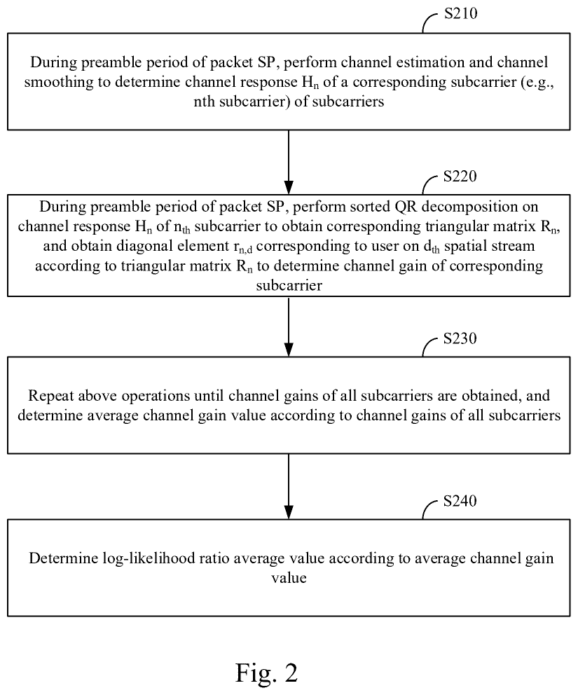

FIG. 2 illustrates a flowchart illustrating the operations of the channel gain estimation circuit 110 in FIG. 1 according to some embodiments of the present disclosure. In operation S210, during a preamble period of a packet SP, channel estimation and channel smoothing are performed to determine a channel response Hₙ of a corresponding subcarrier (e.g., the nₜₕ subcarrier) of subcarriers. For example, the channel gain estimation circuit 110 may perform a channel estimation algorithm according to the preamble PS during the preamble period of the packet SP to determine the channel response corresponding to each of the subcarriers used to transmit the packet SP. In operation S220, during the preamble period of the packet SP, a sorted QR decomposition (SQRD) is performed on the channel response Hₙ of the nₜₕ subcarrier to obtain a corresponding triangular matrix Rₙ, and diagonal element r_{n,d} corresponding to a user on the dₜₕ spatial stream is obtained according to the triangular matrix Rₙ to determine the channel gain of the corresponding subcarrier (e.g., the average channel gain value).

For example, the channel gain estimation circuit 110 may estimate the channel response Hₙ of the nₜₕ subcarrier based on the preamble PS of the packet SP, and perform a sorted QR decomposition on the channel response Hₙ to obtain a corresponding orthogonal matrix Qₙ and a triangular matrix Rₙ. The above operation can be expressed by the following equation:

$${H}_{n} ≡ {Q}_{n} \cdot {R}_{n}$$

where Hₙ represents the channel response of the nₜₕ subcarrier and may be expressed in matrix form, Qₙ is the orthogonal matrix corresponding to the nₜₕ subcarrier, and Rₙ is the triangular matrix corresponding to the nₜₕ subcarrier. For example, assuming that the application environment of the MIMO OFDM communication system 100 in FIG. 1 includes two transmitter antennas and two receiver antennas, and supports simultaneous data transmission for two users, the triangular matrix Rₙ obtained through the sorted QR decomposition can be as follows:

$${R}_{n} ≡ [ \begin{matrix}{r}_{n , 1} & * & * & * \\ 0 & {r}_{n , 2} & * & * \\ 0 & 0 & {r}_{n , 3} & * \\ 0 & 0 & 0 & {r}_{n , 4}\end{matrix} ]$$

The triangular matrix Rₙ includes diagonal elements r_{n,1}, r_{n,2}, r_{n,3}, and r_{n,4}. In this example, the diagonal elements r_{n,1} and r_{n,2} correspond to the first user, while the diagonal elements r_{n,3} and r_{n,4} correspond to the second user. As a result, the channel gain estimation circuit 110 may obtain diagonal elements r_{n,1}, r_{n,2}, r_{n,3}, and r_{n,4} and calculate the square value of each of them

$$( i . e . , {r}_{n , 1}^{2} , {r}_{n , 2}^{2} , {r}_{n , 3}^{2} , and {r}_{n , 4}^{2} ) .$$

In some embodiments, the square values of the multiple diagonal elements r_{n,1}, r_{n,2}, r_{n,3}, and r_{n,4} may be considered as the channel gains of the nₜₕ subcarrier on different antennas for different users. It may be understood that in the above example, the triangular matrix Rₙ is an upper triangular matrix, and therefore some elements are marked with an asterisk (*) and may be arbitrary values. In other examples, the triangular matrix Rₙ may also be a lower triangular matrix, and the present disclosure is not limited thereto.

In some embodiments, to further simplify the operation, the channel gains corresponding to the same subcarrier for the same user may be set to the same value. For example, the first spatial stream and the second spatial stream (allocated to the first user) correspond to the diagonal elements r_{n,1} and r_{n,2}, respectively, while the third spatial stream and the fourth spatial stream (allocated to the second user) correspond to the diagonal elements r_{n,3} and r_{n,4}, respectively. In some embodiments, the channel gain estimation circuit 110 may configure the channel gains corresponding to the same user for one subcarrier to be the same value according to the current signal-to-noise ratio of the application environment. For example, when the current signal-to-noise ratio is higher than a predetermined value, the channel gain estimation circuit 110 may configure the channel gain of the nₜₕ subcarrier for the first user to be the smaller one of the square values of the diagonal elements r_{n,1} and r_{n,2}. Alternatively, when the current signal-to-noise ratio is not higher than the predetermined value, the channel gain estimation circuit 110 may configure the channel gain to be the average of the square values of the diagonal elements r_{n,1} and r_{n,2}. The above operations may be derived as the following function:

$${\tilde{r}}_{u , n}^{2} ≡ \{ \begin{matrix}{min}_{d ∈ {φ}_{u}} ( {r}_{n , d}^{2} ) , when SNR is higher than predetermined value \\ {min}_{d ∈ {φ}_{u}} ( {r}_{n , d}^{2} ) , when SNR is not higher predetermined value\end{matrix}$$

$${φ}_{u} ≡ \{ d \vert d belongs to {u}_{th} user \}$$

$${\overline{G}}_{u , r} ≡ {E}_{n} \{ {\tilde{r}}_{u , n}^{2} \}$$

$$where {\tilde{r}}_{u , n}^{2}$$

represents the channel gain of the nₜₕ subcarrier corresponding to the uₜₕ user (i.e., the channel gain in operation S220), and φᵤ is a set of values d corresponding to the uₜₕ user. For example, if u is 1, the values of d include 1 and 2, which correspond to the first user. Accordingly, the channel gain estimation circuit 110 may obtain the channel gain of the nₜₕ subcarrier corresponding to the uₜₕ user.

In operation S230, the above operations are repeated until the channel gains of all subcarriers are obtained, and the average channel gain value is then determined according to the channel gains of all subcarriers. For example, by repeating the above operations, the channel gain estimation circuit 110 may obtain the channel gains of all subcarriers corresponding to the uₜₕ user, and take the average over frequency (e.g., an average of all subcarriers) to obtain the average channel gain value corresponding to the uₜₕ user. The above operation can be expressed by the following equation:

$${\overline{G}}_{u , r} ≡ {E}_{n} \{ {\tilde{r}}_{u , n}^{2} \}$$

G̅_{u,r} represents an average channel gain value corresponding to the uₜₕ user. In operation S240, a log-likelihood ratio average value is determined according to the average channel gain value. For example, the channel gain estimation circuit 110 may obtain the log-likelihood ratio average value through the operation of Equation (1) below:

$${E}_{t} \{ {\vert LLR \vert}_{n , d} \} ≅ K \cdot {r}_{n , d}^{2} ≅ K \cdot {\overline{G}}_{u , r} \qquad ( 1 )$$

In some embodiments, the LLR in Equation (1) may be generated by the maximum likelihood detection circuit 130 according to the preamble PS of the packet SP (which may be, for example, but not limited to, symbols in a long training field). In Equation (1),

$${r}_{n , d}^{2}$$

represents the square of a diagonal element in the triangular matrix Rₙ (e.g., diagonal elements r_{n,1}, r_{n,2}, r_{n,3}, and r_{n,4}), n is the subcarrier index (e.g., n may range from 1 to NSC, where NSC is the total number of subcarriers), d is the row index of the triangular matrix Rₙ (i.e., d=1, 2, 3, 4), and K is a predetermined parameter, which may be expressed as

$$\frac{{( αΔ )}^{2}}{{σ}_{a}^{2}} ,$$

where α is the normalization factor for quadrature amplitude modulation (QAM), Δ is the minimum distance between constellation points,

$${σ}_{a}^{2}$$

is the noise power on the preamble PS, and t is the index of the preamble PS. In some embodiments, the parameters Δ and α in Equation (1) may be known during system design, and the noise power

$${σ}_{a}^{2}$$

may be estimated by other circuits in the system. For example, in some embodiments, the MIMO OFDM communication system 100 may include a noise estimation circuit (not shown), which may use operations such as maximum likelihood estimation (MLE), minimum mean-square error (MMSE) estimation, or other algorithms to estimate the noise power according to the preamble PS of the packet SP, but the present disclosure is not limited thereto.

According to Equation (1), the channel gain estimation circuit 110 may calculate the log-likelihood ratio average value according to the squared values of multiple diagonal elements in the triangular matrix and the predetermined parameter K. In some embodiments, to further simplify the process, the channel gain estimation circuit 110 may use the average channel gain value G̅_{u,r} in place of the squared values of the diagonal elements

$${r}_{n , d}^{2}$$

in the triangular matrix in Equation (1), thereby determining the log-likelihood ratio average value (e.g., K·G̅_{u,r} in Equation (1)) based on the average channel gain value G̅_{u,r} and the predetermined parameter K. As a result, in scenarios with lower signal-to-noise ratios, higher channel gains may be used for calculation to avoid excessive distortion in the final estimated log-likelihood ratio.

In some embodiments, the derivation concept of Equation (1) is briefly described as follows. The log-likelihood ratio corresponding to the iₜₕ bit on the mₜₕ layer may be expressed as:

$$L L {R}_{m , i} = {{min}_{{x}^{( k )} ∈ {φ}_{m , i}^{0}} ( {‖ y - H \cdot {x}^{( k )} ‖}_{F} )}^{2} - {{min}_{{x}^{( k )} ∈ {φ}_{m , i}^{1}} ( {‖ y - H \cdot {x}^{( k )} ‖}_{F} )}^{2}$$

It represents the difference between the minimum distance between the received signal y and the candidate signal (which may be bit 0 and bit 1, respectively) at a specific bit position. Furthermore, the received signal y may be expressed as:

$$y = H \cdot x + N$$

where x is the transmitted signal, H is the channel response, and N is noise (e.g., additive white Gaussian noise (AWGN) with zero mean and variance). In high signal-to-noise ratio scenarios, the signal power is much greater than the noise power, such that the distance between the received signal y and the candidate signal is primarily determined by the minimum distance between constellation points (i.e., the aforementioned parameter Δ). Taking constellation point X₀ as an example, the distance can be expressed as:

$${( {‖ y - H \cdot {x}_{0} ‖}_{F} )}^{2} ≅ {‖ Δ ‖}^{2} + {‖ N ‖}^{2}$$

Thus, from the above equation, it can be understood that the log-likelihood ratio average value may be proportional to the square of the parameter Δ. On the other hand, in general, when the noise power

$${σ}_{a}^{2}$$

of the noise N is higher, the value of the log-likelihood ratio is lower. That is, the mean of the log-likelihood ratio is usually inversely proportional to the noise power. Accordingly, after comprehensively considering factors such as normalization, the parameter Δ, the noise power

$${σ}_{a}^{2} ,$$

and the subcarrier index of each subcarrier, the approximated log-likelihood ratio average value may be derived by equation (1).

Accordingly, the scaling factor estimation circuit 120 may determine the scaling factor SF during the preamble period of the packet SP according to the scaling parameter N_{mid}, the average channel gain value, and the channel gain of the nₜₕ subcarrier. For example, the scaling factor estimation circuit 120 may normalize the average channel gain value using the channel gain of the nₜₕ subcarrier to obtain a normalized result, and multiply the normalized result by the scaling parameter N_{mid} to generate a gain parameter. The scaling factor SF is then determined according to the mutual information between the gain parameter and the output of the quantizer circuit 160. The operation for determining the gain parameter may be expressed by the following equation:

$${\overline{r}}_{u , n}^{2} ≡ \frac{{\tilde{r}}_{u , n}^{2}}{{\overline{G}}_{u , r}} \cdot {N}_{m i d}$$

where G̅_{u,r} is the average channel gain value,

$${\tilde{r}}_{u , n}^{2}$$

is the channel gain of the nₜₕ subcarrier, and

$${\overline{r}}_{u , n}^{2}$$

is the aforementioned gain parameter.

It is understood that, in order to reduce the implementation complexity of the channel decoder circuit 170, the target is to maximize the mutual information between the output of the quantizer circuit 160 and the signal before being adjusted by the scaling factor SF (i.e., the input of the scaling circuit 150). In other words, the scaling factor SF is intended to maximize the amount of information about the input of the scaling circuit 150 that can be obtained by observing the output of the quantizer circuit 160 (which is equivalent to minimizing the information loss of the signal processed by the scaling factor SF). The mutual information mentioned above may be expressed by the following equation:

$$I ( x , {y}_{β} ) ≡ {\sum }_{n} {\sum }_{m} {P}_{r} ( {x}_{n} , {y}_{m , β} ) \cdot log \frac{{P}_{r} ( {x}_{n} , {y}_{m , β} )}{{P}_{r} ( {x}_{n} ) \cdot {P}_{r} ( {y}_{m , β} )}$$

$$Q ( β x ) = {y}_{β}$$

where I(x,y_{β}) is the mutual information, x is the input of the scaling circuit 150, SF is the scaling factor, y is the output of the quantizer circuit 160, Pᵣ(xₙ) is the probability mass function of x, Pᵣ(y_{m,β})) is the probability mass function of y_{β}, Pᵣ(xₙ,y_{m,β}) is the joint probability mass function of x and y_{β}, and Q(βx) is the quantization function of the quantizer circuit 160.

As mentioned above, the goal is to find a scaling factor SF that maximizes the mutual information I(x,y_{β}), which may be expressed by the following equation:

$$\hat{β} ≡ {Arg}_{β} Max I ( x , Q ( β x ) )$$

where \hat{β} is the estimated scaling factor SF.

In order to simplify circuit implementation, the following mathematical concepts may be used to simplify the above equation. First, the joint probability mass function mentioned above may be expanded as follows:

$${P}_{r} ( {x}_{n} , {y}_{m , β} ) = {P}_{r} ( {y}_{m , β} \vert {x}_{n} ) \cdot {P}_{r} ( {x}_{n} ) = δ [ {y}_{m , β} - Q ( β \cdot {x}_{n} ) ] \cdot {P}_{r} ( {x}_{n} ) = δ [ {y}_{m , β} - Q ( β \cdot {x}_{n} ) ] \cdot \frac{{N}_{x} [ {\overline{x}}_{n} ]}{{N}_{sc}}$$

$${x}_{n} = u 〈 {n}_{xT} , {n}_{xf} 〉 , {\overline{x}}_{n} ≡ {x}_{n} \cdot {2}^{{n}_{xf}}$$

$${y}_{m , β} = u {〈 {n}_{yT} , 0 〉}_{2} , {\overline{y}}_{m , β} ≡ {y}_{m , β} \cdot {2}^{{n}_{yf}} = {y}_{m , β}$$

$${P}_{r} ( {x}_{n} ) = \frac{{N}_{x} [ {\overline{x}}_{n} ]}{{N}_{sc}}$$

$${P}_{r} ( {y}_{m , β} ) = \frac{{N}_{y} [ {y}_{m , β} ]}{{N}_{sc}}$$

where δ[k] is the Kronecker delta function. When k equals 0, the function outputs 1; when k does not equal 0, the function outputs 0. NSC is the total number of subcarriers. Furthermore, u [symbol] a, b [symbol] is an operator used to generate unsigned digital numbers (e.g., C, which may be xₙ or y_{m,β} in the above equation), where a is the number of integer bits, b is the number of fractional bits, and the function C̅=C·2^{b} is used to shift C into a value with no fractional part. Nₓ[\hat{x}ₙ] is the number of times the value x̅ₙ appears in the set x, and N_{y}[y_{m,β}] is the number of times the value y appears in the set y.

Substituting the above expanded joint probability mass function Pᵣ(xₙ, y_{m,β}) into the above mutual information I, the following can be obtained:

$$I ( x , {y}_{β} ) ≡ {\sum }_{n} {\sum }_{m} {P}_{r} ( {x}_{n} , {y}_{m , β} ) \cdot log \frac{{P}_{r} ( {x}_{n} , {y}_{m , β} )}{{P}_{r} ( {x}_{n} ) {P}_{r} ( {y}_{m , β} )} = {\sum }_{n} {\sum }_{m} \frac{{N}_{x} [ {\overline{x}}_{n} ]}{{N}_{sc}} \cdot δ [ {y}_{m , β} - Q ( β \cdot {x}_{n} ) ] \cdot log \frac{1}{{P}_{r} ( {y}_{m , β} )} = \frac{- 1}{{N}_{sc}} \cdot {\sum }_{n} {N}_{x} [ {\overline{x}}_{n} ] \cdot {\sum }_{m} δ [ {y}_{m , β} - Q ( β \cdot {x}_{n} ) ] \cdot log {P}_{r} ( {y}_{m , β} ) = \frac{- 1}{{N}_{sc}} \cdot {\sum }_{n} {N}_{x} [ {\overline{x}}_{n} ] \cdot log {P}_{r} ( {y}_{m , β} = Q ( β \cdot {x}_{n} ) ) = \frac{- 1}{{N}_{sc}} \cdot {\sum }_{n} {N}_{x} [ {\overline{x}}_{n} ] \cdot \{ log {N}_{y} [ Q ( β \cdot {x}_{n} ) ] - log [ {N}_{sc} ] \} = \frac{log ( {N}_{sc} )}{{N}_{sc}} \cdot {\sum }_{n} {N}_{x} [ {\overline{x}}_{n} ] - \frac{1}{{N}_{sc}} \cdot {\sum }_{n} {N}_{x} [ {\overline{x}}_{n} ] \cdot log {N}_{y} [ Q ( β \cdot {x}_{n} ) ] = log ( {N}_{sc} ) - \frac{1}{{N}_{sc}} \cdot {\sum }_{n} {N}_{x} [ {\overline{x}}_{n} ] \cdot log {N}_{y} [ Q ( β \cdot {x}_{n} ) ]$$

From the above equation, it can be seen that to maximize the mutual information I, the term on the right side of the minus sign should be minimized. Therefore, based on the above information, the scaling factor SF may be rewritten as follows:

$$\hat{β} ≡ {Arg}_{β} Max I ( x , {y}_{β} ) = {Arg}_{β} Max I ( x , Q ( β x ) ) = {Arg}_{β} Min \{ {\sum }_{n ∈ φ} {N}_{x} [ {\overline{x}}_{n} ] \cdot log {N}_{y} [ Q ( β \cdot {x}_{n} ) ] \} = {Arg}_{β} Min {J}_{x , y} ( β )$$

$$where {J}_{x , y} ( β ) ≡ {\sum }_{n ∈ φ} {N}_{x} [ {\overline{x}}_{n} ] \cdot log {N}_{y} [ Q ( β \cdot {x}_{n} ) ] .$$

Accordingly, it is understood that the scaling factor SF (i.e., β in the above equation) is intended to minimize a function J_{x,y}(β), which may be expressed by the following equation (2):

$${J}_{x , y} ( β ) ≡ {\sum }_{n} {N}_{x} [ {\overline{x}}_{n} ] \cdot log {N}_{y} [ Q ( β \cdot {x}_{γ} ) ] = {\sum }_{n = 0}^{{L}_{x} - 1} {N}_{x} [ n ] \cdot log {N}_{y} [ Q ( β \cdot n \cdot {2}^{- {n}_{yT}} ) ] = {\sum }_{m = 0}^{{L}_{y} - 1} ( {\sum }_{n ∈ {Ω}_{m}} {N}_{x} [ n ] ) \cdot log {N}_{y} [ m ] = {\sum }_{m = 0}^{{L}_{y} - 1} {N}_{y} [ m ] \cdot log {N}_{y} [ m ] \qquad ( 2 )$$

where Σ_{n∈Ω}_{ₘ}Nₓ[n]=N_{y}[m], Ωₘ≡{n|Q(β·n·2⁻ⁿ^{_{yT}})=m}, L_{X} is the total number of quantization levels corresponding to the set x, L_{y} and is the total number of quantization levels corresponding to the set y.

Accordingly, the scaling factor estimation circuit 120 may set the above gain parameter as the signal xₙ in equation (2) (corresponding to the input of the scaling circuit 150), and set the scaling factor SF (corresponding to β in equation (2)) as a specific value, and record the number of quantization levels mapped by the output of the quantizer circuit 160. As a result, by repeating the above steps, the scaling factor SF that minimizes equation (2) may be found. In other words, according to equation (2), the scaling factor estimation circuit 120 may determine the scaling factor SF according to the mutual information between the gain parameter

$${\overline{r}}_{u , n}^{2}$$

and the output of the quantizer circuit 160 (corresponding to the aforementioned I(x,y_{β})).

For example, if the word length of the log-likelihood ratio that corresponds to input to the scaling circuit 150 is set to 11, and the word length of the log-likelihood ratio that corresponds to the output of the quantizer circuit 160 is set to 6. Under this condition, if the decoding mechanism of the channel decoder circuit 170 operates based on a low-density parity-check (LDPC) code, the total number of quantization levels Ly processed by the channel decoder circuit 170 may be set to 32. Alternatively, if the decoding mechanism of the channel decoder circuit 170 operates based on a binary convolutional code (BCC), the total number of quantization levels Ly may be set to 16. Taking the case where the total number of quantization levels Ly is set to 32 as an example, during the preamble period of the packet SP, the scaling factor estimation circuit 120 may input the gain parameter

$${\overline{r}}_{u , n}^{2}$$

into the scaling circuit 150, set the scaling factor SF to a first value, and record how many of the 32 quantization levels are mapped. The number of quantization levels recorded is N_{y}[m] in equation (2). Then, the scaling factor estimation circuit 120 may set the scaling factor SF to a second value and record the number of quantization levels again. By repeating the above process, the scaling factor estimation circuit 120 may find the scaling factor SF that minimizes equation (2).

In some embodiments, the scaling factor SF has a predetermined value range, and the scaling factor estimation circuit 120 may sequentially set the scaling factor SF to different values within this predetermined range to perform the above operations. In some embodiments, the aforementioned predetermined value range may be determined through circuit simulations and/or pre-measurements, but the present disclosure is not limited thereto.

With the above operations, the MIMO OFDM communication system 100 may determine an appropriate scaling factor SF during the preamble period of the packet SP, thereby reducing the word length of the original log-likelihood ratio sequence OLR while maintaining maximum data relevance (e.g., maximizing the aforementioned mutual information). As a result, the complexity and hardware cost of the channel decoder circuit 170 may be reduced (e.g., reducing the length of data to be processed and the number of buffers used), while also maintaining reliable data decoding performance. Accordingly, it is understood that by identifying an appropriate scaling factor SF, significant improvements can be brought to circuit applications in the OFDM communication field.

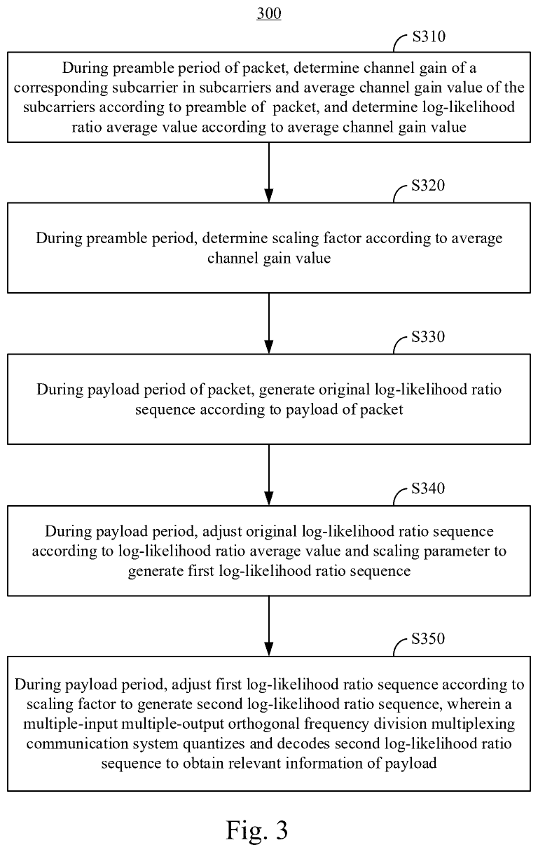

FIG. 3 illustrates a flowchart illustrating a log-likelihood ratio scaling method 300 according to some embodiments of the present disclosure. In some embodiments, the log-likelihood ratio scaling method 300 may be performed by a multiple-input multiple-output orthogonal frequency division multiplexing communication system (e.g., but not limited to, the MIMO OFDM communication system 100 shown in FIG. 1).

In operation S310, during a preamble period of a packet, a channel gain of a corresponding subcarrier in a plurality of subcarriers and an average channel gain value of the plurality of subcarriers are determined according to the preamble of the packet, and a log-likelihood ratio average value is determined according to the average channel gain value. In operation S320, during the preamble period, a scaling factor is determined according to the average channel gain value. In operation S330, during a payload period of the packet, an original log-likelihood ratio sequence is generated according to the payload of the packet. In operation S340, during the payload period, the original log-likelihood ratio sequence is adjusted according to the log-likelihood ratio average value and the scaling parameter to generate a first log-likelihood ratio sequence. In operation S350, during the payload period, the first log-likelihood ratio sequence is adjusted according to the scaling factor to generate a second log-likelihood ratio sequence, wherein a multiple-input multiple-output orthogonal frequency division multiplexing communication system quantizes and decodes the second log-likelihood ratio sequence to obtain relevant information of the payload.

The above operations can be understood with reference to the above embodiments, and thus repetitious descriptions are not further given. The above operations and/or steps in the log-likelihood ratio scaling method 300 include exemplary operations, but those operations are not necessarily performed in the order described above. Operations and/or steps in the log-likelihood ratio scaling method 300 may be added, replaced, changed order, and/or eliminated. Alternatively, operations and/or steps in the log-likelihood ratio scaling method 300 may be performed simultaneously or partially simultaneously as appropriate, in accordance with the spirit and scope of various embodiments of the present disclosure

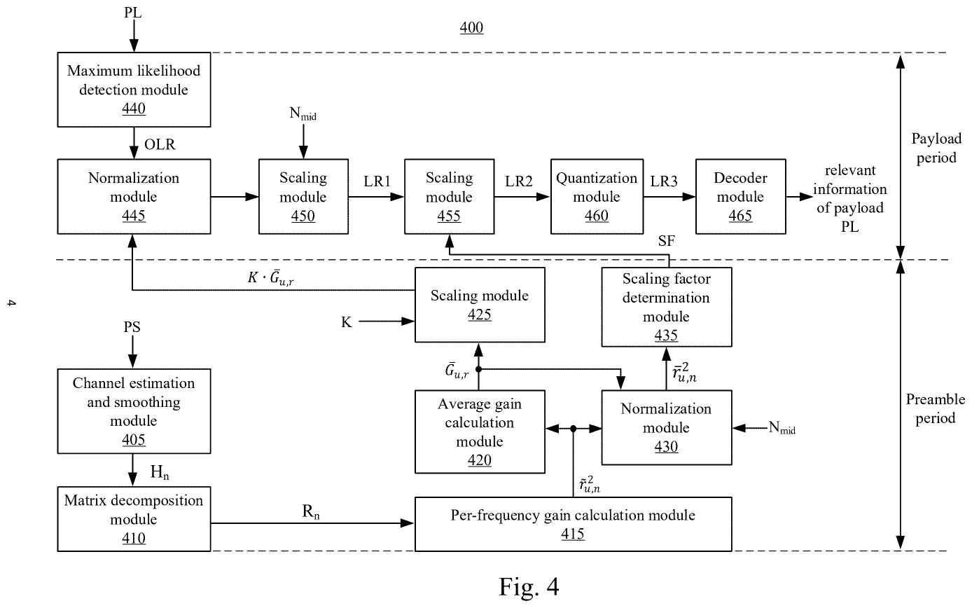

FIG. 4 illustrates a schematic diagram of a log-likelihood ratio scaling mechanism 400 according to some embodiments of the present disclosure. In some embodiments, the log-likelihood ratio scaling mechanism 400 may be implemented by the MIMO OFDM communication system 100 in FIG. 1, but the present disclosure is not limited thereto. The log-likelihood ratio scaling mechanism 400 includes a channel estimation and smoothing module 405, a matrix decomposition module 410, a per-frequency gain calculation module 415, an average gain calculation module 420, a scaling module 425, a normalization module 430, a scaling factor determination module 435, a maximum likelihood detection module 440, a normalization module 445, a scaling module 450, a scaling module 455, a quantization module 460, and a decoder module 465. The operations of the channel estimation and smoothing module 405, the matrix decomposition module 410, the per-frequency gain calculation module 415, the average gain calculation module 420, the scaling module 425, the normalization module 430, and the scaling factor determination module 435 are performed during the preamble period of the packet SP, while the operations of the maximum likelihood detection module 440, the normalization module 445, the scaling module 450, the scaling module 455, the quantization module 460, and the decoder module 465 are performed during the payload period of the packet SP.

The channel estimation and smoothing module 405, the matrix decomposition module 410, the per-frequency gain calculation module 415, the average gain calculation module 420, and the scaling module 425 may correspond to the channel gain estimation circuit 110 in FIG. 1. The channel estimation and smoothing module 405 may estimate a channel response Hₙ of the nₜₕ subcarrier during a preamble period according to a preamble PS of a packet SP. The matrix decomposition module 410 may perform the aforementioned sorted QR decomposition on the channel response Hₙ of the nₜₕ subcarrier during the preamble period to obtain a triangular matrix Rₙ. The per-frequency gain calculation module 415 may obtain a channel gain

$${\tilde{r}}_{u , n}^{2}$$

corresponding to each subcarrier during the preamble period according to the triangular matrix Rₙ (for example, but not limited to, a square value of a diagonal element of the triangular matrix Rₙ). The average gain calculation module 420 may determine an average channel gain value G̅_{u,r}) during the preamble period according to the channel gain

$${\tilde{r}}_{u , n}^{2}$$

of each subcarrier. The scaling module 425 may adjust the average channel gain value G̅_{u,r} during the preamble period according to the aforementioned predetermined parameter K, so as to determine a log-likelihood ratio average value K·G̅_{u,r}. In some embodiments, the channel gain estimation circuit 110 may be implemented with at least one digital signal processing circuit or microcontroller circuit having processing capability sufficient to perform operations of the aforementioned modules, but the present application is not limited thereto.

The normalization module 430 and the scaling factor determination module 435 may correspond to the scaling factor estimation circuit 120 shown in FIG. 1. The normalization module 430 may normalize the average channel gain value G̅_{u,r} according to the channel gain

$${\tilde{r}}_{u , n}^{2}$$

of each subcarrier, and multiply the normalized result by a scaling parameter N_{mid} to determine the aforementioned gain parameter

$${\overline{r}}_{u , n}^{2} .$$

The scaling factor determination module 435 may determine a scaling factor SF according to mutual information between the gain parameter

$${\overline{r}}_{u , n}^{2}$$

and an output of a quantization module 460 (which may correspond to the quantizer circuit 160 in FIG. 1). In some embodiments, the scaling factor estimation circuit 120 may be implemented with at least one digital signal processing circuit or microcontroller circuit having processing capability sufficient to perform operations of the aforementioned modules, but the present application is not limited thereto.

The maximum likelihood detection module 440 may correspond to the maximum likelihood detection circuit 130 shown in FIG. 1, and may generate an original log-likelihood ratio sequence OLR during a payload period of the packet SP according to a payload PL. The normalization module 445 may correspond to the normalization circuit 142 shown in FIG. 1, and may normalize the original log-likelihood ratio sequence OLR according to the average channel gain value G̅_{u,r} during the payload period, so as to generate a log-likelihood ratio sequence LR1. The scaling module 450 may correspond to the multiplier circuit 144 shown in FIG. 1, and may multiply the scaling parameter N_{mid} and the log-likelihood ratio sequence LR1 during the payload period to generate a log-likelihood ratio sequence LR2. The scaling module 455 may correspond to the scaling circuit 150 in FIG. 1, and may multiply the scaling factor SF and the log-likelihood ratio sequence LR2 during the payload period to generate a log-likelihood ratio sequence LR3. The quantization module 460 may correspond to the quantizer circuit 160 shown in FIG. 1, and may quantize the log-likelihood ratio sequence LR3 during the payload period to generate quantized data QD. The decoder module 465 may correspond to the channel decoder circuit 170 in FIG. 1, and may decode the quantized data QD during the payload period to provide relevant information of the payload PL.

In some embodiments, various modules in FIG. 4 may be implemented with one or more digital circuits. Alternatively, in other embodiments, various modules in FIG. 4 may be implemented with at least one software program, and the at least one software program may be executed by at least one digital signal processing circuit to realize the corresponding operations.

As described above, a MIMO OFDM communication system and a log-likelihood ratio scaling method provided in some embodiments of the present application may identify an appropriate scaling factor during the preamble period of a packet through mutual information to reduce the log-likelihood ratio sequence. As a result, overall system power consumption can be significantly reduced, thereby improving power saving.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present disclosure, without any intention to limit the scope of the present disclosure thereto. Various equivalent changes, alterations, or modifications according to the claims of the present disclosure are all consequently viewed as being embraced by the scope of the present disclosure.

What is claimed is:

1. A multiple-input multiple-output (MIMO) orthogonal frequency division multiplexing communication system, comprising:
a channel gain estimation circuit configured to, during a preamble period of a packet, determine a channel gain of a corresponding subcarrier in a plurality of subcarriers and an average channel gain value of the plurality of subcarriers according to a preamble of the packet, and determine a log-likelihood ratio average value according to the average channel gain value;
a scaling factor estimation circuit configured to, during the preamble period, determine a scaling factor according to the average channel gain value, the channel gain of the corresponding subcarrier, and a scaling parameter;
a maximum likelihood detection circuit configured to, during a payload period of the packet, generate an original log-likelihood ratio sequence according to a payload of the packet;
a first scaling circuit configured to, during the payload period, adjust the original log-likelihood ratio sequence according to the log-likelihood ratio average value and the scaling parameter to generate a first log-likelihood ratio sequence;
a second scaling circuit configured to, during the payload period, adjust the first log-likelihood ratio sequence according to the scaling factor to generate a second log-likelihood ratio sequence;
a quantizer circuit configured to, during the payload period, quantize the second log-likelihood ratio sequence to generate quantized data; and
a channel decoder circuit configured to, during the payload period, decode the quantized data to obtain relevant information of the payload.

2. The MIMO orthogonal frequency division multiplexing communication system of claim 1, wherein the channel gain estimation circuit is configured to, during the preamble period, determine a channel response of the corresponding subcarrier according to the preamble, perform a sorted QR decomposition on the channel response to obtain a triangular matrix, determine the channel gain of the corresponding subcarrier according to a plurality of diagonal elements of the triangular matrix, and determine the average channel gain value.

3. The MIMO orthogonal frequency division multiplexing communication system of claim 1, wherein the first scaling circuit comprises:
a normalization circuit configured to, during the payload period, normalize the original log-likelihood ratio sequence according to the log-likelihood ratio average value to generate a third log-likelihood ratio sequence; and
a multiplier circuit configured to, during the payload period, multiply the scaling parameter and the third log-likelihood ratio sequence to generate the first log-likelihood ratio sequence.

4. The MIMO orthogonal frequency division multiplexing communication system of claim 1, wherein the scaling parameter is determined according to a word length of the original log-likelihood ratio sequence.

5. The MIMO orthogonal frequency division multiplexing communication system of claim 1, wherein the scaling factor estimation circuit is configured to normalize the average channel gain value according to the channel gain of the corresponding subcarrier to obtain a normalized result, multiply the normalized result by the scaling parameter to generate a gain parameter, and determine the scaling factor according to mutual information between the gain parameter and an output of the quantizer circuit.

6. The MIMO orthogonal frequency division multiplexing communication system of claim 5, wherein the scaling factor is configured to maximize the mutual information.

7. A log-likelihood ratio scaling method, executed by a multiple-input multiple-output orthogonal frequency division multiplexing communication system, the log-likelihood ratio scaling method comprising:
during a preamble period of a packet according to a preamble of the packet, determining a channel gain of a corresponding subcarrier in a plurality of subcarriers and an average channel gain value of the plurality of subcarriers, and determining a log-likelihood ratio average value according to the average channel gain value;
during the preamble period, determining a scaling factor according to the average channel gain value, the channel gain of the corresponding subcarrier, and a scaling parameter;
during a payload period of the packet, generating an original log-likelihood ratio sequence according to a payload of the packet;
during the payload period, adjusting the original log-likelihood ratio sequence according to the log-likelihood ratio average value and the scaling parameter to generate a first log-likelihood ratio sequence; and
during the payload period, adjusting the first log-likelihood ratio sequence according to the scaling factor to generate a second log-likelihood ratio sequence,
wherein the multiple-input multiple-output orthogonal frequency division multiplexing communication system quantizes and decodes the second log-likelihood ratio sequence to obtain relevant information of the payload.

8. The log-likelihood ratio scaling method of claim 7, wherein during the preamble period of the packet, determining the average channel gain value of the plurality of subcarriers and determining the log-likelihood ratio average value according to the average channel gain value comprises:
determining a channel response of the corresponding subcarrier according to the preamble;
performing a sorted QR decomposition on the channel response to obtain a triangular matrix; and
determining the channel gain of the corresponding subcarrier based on a plurality of diagonal elements of the triangular matrix, and determining the average channel gain value.

9. The log-likelihood ratio scaling method of claim 7, wherein the second log-likelihood ratio sequence is quantized by a quantizer circuit in the multiple-input multiple-output orthogonal frequency division multiplexing communication system, and determining the scaling factor during the preamble period according to the average channel gain value comprises:
normalizing the average channel gain value according to the channel gain of the corresponding subcarrier to obtain a normalized result, and multiplying the normalized result by the scaling parameter to generate a gain parameter; and
determining the scaling factor according to mutual information between the gain parameter and an output of the quantizer circuit.

10. The log-likelihood ratio scaling method of claim 9, wherein the scaling factor is configured to maximize the mutual information.

11. The log-likelihood ratio scaling method of claim 7, wherein during the payload period, adjusting the original log-likelihood ratio sequence according to the log-likelihood ratio average value and the scaling parameter to generate the first log-likelihood ratio sequence comprises:
during the payload period, normalizing the original log-likelihood ratio sequence according to the log-likelihood ratio average value to generate a third log-likelihood ratio sequence; and
during the payload period, multiplying the scaling parameter and the third log-likelihood ratio sequence to generate the first log-likelihood ratio sequence.

12. The log-likelihood ratio scaling method of claim 7, wherein the scaling parameter is determined according to a word length of the original log-likelihood ratio sequence.
